(19) United States
(12) Patent Application Publication
(10) Pub. No.: US 2004/0098331 A1
(43) Pub. Date: May 20, 2004

(54) Auction bidding using bar code scanning

(76) Inventor: Todd Benson, Rochester Hills, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 10/294,189

(22) Filed: Nov. 14, 2002

(51) Int. Cl. G06F 17/60

(52) U.S. Cl. 705/37

(57) ABSTRACT

A method of administering a silent auction using a computer-implemented auction system includes receiving a bid on an item up for auction from the user via a computer system. Encoded information embodied in a computer-readable recording medium is captured via the computer system, and the computer system recognizes the user based on the encoded information. The computer system processes the bid in response to successful recognition of the user.

### FIELD OF THE INVENTION

The present invention generally relates to computer-automated user identification and authorization systems and methods, and particularly relates to computer-automated identification of registered silent auction bidders using a computer-readable recording medium.

### BACKGROUND OF THE INVENTION

Silent charity auctions are social occasions that benefit from the physical presence of auction bidders and the ability of bidders to socially interact with one another in a relaxed environment free of the distractions associated with audible auction activity. In the past, bidders have enjoyed the ability to view items up for auction and/or documentation representing items up for auction, to view the top bid amount and top bidder's identity, and to submit bids on paper by replacing the top bid with a higher bid and identifying themselves. This previous method of operating a silent auction suffers, however, from issues of security. For example, security measures associated with the previous method essentially amount to reliance on the honor system, such that bidders are trusted not to replace a previous bidder's bid with a lower bid. For this and similar reasons, computer-automated bidding has been implemented in silent charity auctions.

Computer-automated bidding in a silent charity auction provides several advantages over the previous method. For example, computer automation allows bidders to view all of the items up for auction in one place, as well as the top bids on all of the items, thus eliminating the need to navigate the entire auction floor. Also, computer-automated bidding prevents users from entering a bid on an item if it is lower than the top bid, thus adding a level of security. Further, computer-automated bidding facilitates the bidding process by allowing bidders to place all desired bids in one session, and concurrently check the bid status on bids placed in a previous session. Thus, computer-automated bidding in a silent charity auction increases security, and generally decreases time required for bidding activity that detracts from time for social activity.

Despite all of its previously discussed advantages, however, computer-automated bidding in a silent charity auction can still be improved, particularly with regard to the sign-on procedure for initiating a session. Specifically, existing computer-automated bidding systems generally require a user (bidder) to register by manually entering personal information sufficient to identify the user for payment purposes. Thence, each time a user wishes to place bids and/or check the status on a previously placed bid, it is necessary for the bidder to manually re-enter some or all of the personal information. As a result of the existing sign-on procedure, users are faced with a tedious process that can discourage bidding, be prone to errors (especially if a pass code or pass phrase is initiated at registration), and exhibit security issues where other bidders can view a user signing on repeatedly. Thus, the need remains for a solution to the aforementioned problems associated with automated identification of users in a silent auction that successfully addresses ease of use and security issues. The present invention provides such a solution.

### SUMMARY OF THE INVENTION

A method of administering a silent auction using a computer-implemented auction system includes receiving a bid on an item up for auction from the user via a computer system. Encoded information embodied in a computer-readable recording medium is captured via the computer system, and the computer system recognizes the user based on the encoded information. The computer system processes the bid in response to successful recognition of the user.

The present invention is advantageous over previous automated auction systems in that it allows users to sign on to a session without having to manually enter identifying information. It is further advantageous because it prevents other bidders from gaining access to the user's bid history or otherwise interfering with the proper process of the auction so long as the user retains physical possession of the computer-readable recording medium. The present invention, therefore succeeds in facilitating the sign on procedure, thus increasing time for social interaction, while increasing security. Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an overhead, schematic view of a silent auction environment employing the present invention and having a registration environment;

FIG. 2 is a block diagram of the automated auction system according to the present invention; and

FIG. 3 is a flow chart depicting a method of operating an auction according to the present invention.

### DETAILED DESCRIPTION OF THE PREFERRED EMBODIMENTS

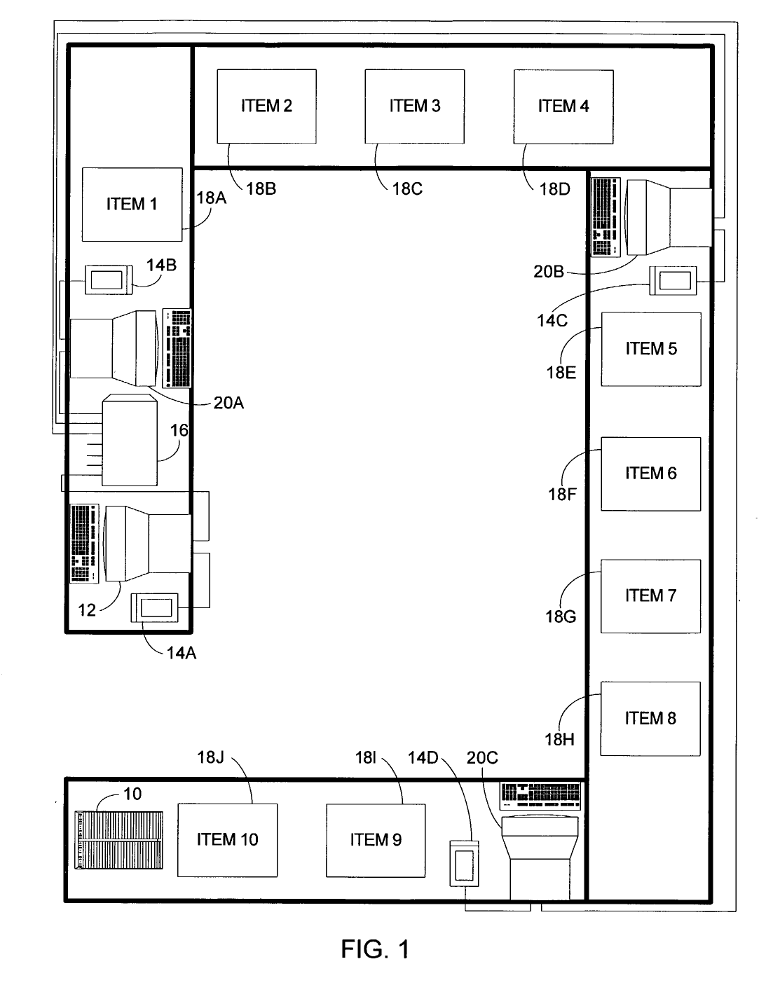

The present invention is described below with reference to use of a registration process that correlates a registered user's identifying information with a bid code, and a bidding process that assumes user possession of a substrate (card) having the bid code recorded thereupon in the form of a bar code. It should be readily understood, however, that other types of recording media can be used including a magnetic strip on a card, a flash memory in a key chain or pen, and a laser-readable disc. It should also be understood that the registration and bidding process can employ biometrics, thereby registering and/or identifying a user based on one or more behavioral and/or physical characteristics including fingerprint, retinal pattern, facial characteristics, voiceprint, DNA, and similar measurable biometrics. Thus, in some situations, the user can comprise the computer readable recording medium within the meaning of the present invention. It should also be understood that, although the present invention is described below as employing a registration process, it is also possible to accomplish the present invention using existing databases of user identifying data, or where the information contained in a computer readable recording medium is inherently sufficient to identify a user for bidding purposes. For example, users may be able to swipe a credit card to initiate a session and have any winning bids charged to the card. Also, users may be able to swipe a driver's license having a magnetic strip if the associated government's driving records are available. Further, a public database may become available that provides telephone and address information for users coincident with biometrics information. The present invention is described more fully below with references to FIGS. 1-3.

Referring to FIG. 1, a plurality of exhibit surfaces (such as tables) are configured to provide an enclosure delineating an auction environment (or auction gallery). Bidders entering the auction gallery take possession of a bid card from a provided set of bid cards 10 as part of a registration process performed in a registration environment (auction gallery entrance). Each of the bid cards has a bid code encoded thereon in the form of a bar code that is unique with respect to each of the other bid codes in the set of bid cards 10. The bid card is standard business card-sized, and the bid code is based on a standard UPC-A barcode. Having taken physical possession of a bid card, a particular user enters uniquely identifying personal information (such as first and last name) at registration terminal 12. Completion of the registration process is then accomplished by scanning the bar code on the bid card using a hand-held bar code scanner 14A attached to the registration terminal 12. The user identifying information is then automatically associated with the unique bid code encoded in the bid card by storing the user-identifying information and bid code in a registration database stored in server 16. It should be understood that the registration process may also be accomplished by mail, such that user identifying information is acquired by auction personnel and associated with a bid code. Thence, a card may be sent to a user as part of an invitation and preregistration process and/or given to a user upon arrival.

Following the registration process, the registered user enters the auction gallery and enjoys the opportunity to view exhibits 18A-J that include individual items up for auction and/or documentation describing the individual items up for auction. The registered user also enjoys the opportunity to view top bids and place bids for items up for auction at any one of several bidding terminals 20A-C disposed at convenient locations within the auction gallery. Information relating to the items up for auction is stored in a database in server 16, such that a user may browse items and view top bids on items using any available bidding terminal 20A-C. A user can manually enter a bid amount for an item up for auction or elect to place the next highest bid according to a predetermined bid increment, and confirm the bid merely by scanning the bid card with one of the bar code scanners 14B-D attached to the bidding terminals 20A-C. Users may confirm bids and identify themselves with one action that minimizes the amount of time required to perform bidding activity, thus providing more time for social activity and increasing availability of provided bidding terminals for other bidders. Thereafter, users can revisit the bidding terminals 20A-C to view top bids associated with various items up for auction, thereby ascertaining a bid status relating to a previously placed bid, and choose to enter additional bids as desired and in accordance with the procedure described above.

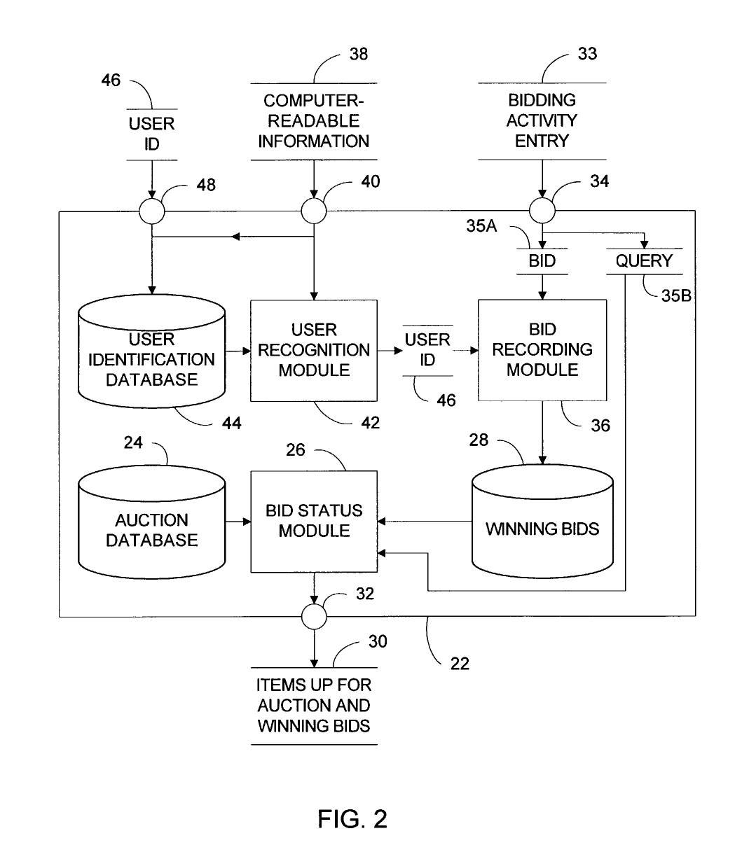

Operation of the automated auction system according to the present invention is described more fully with reference to FIG. 2. Therein, the automated auction system 22 has information relating to a plurality of items up for auction stored in an auction database 24. A bid status module 26 is operable to access the auction database 24 and bid database 28 storing winning bids (currently highest bids) on items up for auction. Upon receiving a bid status query 35B from a user relating to particular items up for auction, the bid status module is adapted to communicate item and bid information 30 to users via an output 32, such as an active display and/or speaker system. Users can enter a bidding activity entry 33 corresponding to a bid via a user interface 34, such as a keyboard, mouse, microphone (with speech recognition), and/or touch screen (possibly with handwritten text recognition), such that a bid increment 35A or multiple thereof is communicated to bid recording module 36. In turn, bid recording module 36 awaits receipt of user-identifying information that identifies the user for billing purposes before confirming the entered bid.

In accordance with the present invention, the user confirms an entered bid by causing the automated auction system 22 to read an associated computer-readable recording medium containing computer-readable information 38. Thus, a user enters computer-readable information 38, such as a bid code or biometric data, via identification interface 40, such as a bar code scanner, magnetic strip reader, disc drive, digital data link, retina scanner, microphone (with voice pattern recognition), touch screen (with handwriting and/or fingerprint recognition), imaging device (with facial and/or fingerprint recognition), and/or other suitable device. As a result, computer-readable information 38 is communicated to recognition module 42, which accesses user identifying information stored in user identification database 44 to perform a user identification 46 based on computer-readable information 38. User identification 46 is thence communicated to bid recording module 36, which records the entered bid in bid database 28 in association with the user identification 46, and further records it as relevant to an item up for bid selected by the user. Thence, bid status module 26 communicates the new winning bid for that item to all prospective bidders via updated item and bid information 30.

As previously discussed, identification database 44 may be provided commercially, such that a user does not have to register to assist in constructing the database. In other instances, however, it may be desirable to have a user provide the user-identifying information comprising the user identification 46 via a registration interface 48, and associate it with the computer-readable information 38, such as a bid code, within the identification database 44. Further, even where a suitable database is available commercially, it may still be desirable to implement a registration procedure as an added measure of security and/or in response to market forces.

It should be readily understood that combination of biometric data with bidding activity entry can result in automatic confirmation of an entered bid that exceeds the highest bid for a selected item. For example, a touch screen implementing a plurality of touch-activated icons signifying next-highest bid increments can use fingerprint recognition to automatically identify a user touching a designated portion of the screen, thereby automatically obtaining the user identification. Similarly, a touch screen-based handwriting interface that allows users to handwrite an entry can perform handwriting pattern recognition on the bid entry to obtain the user identification. Further, a bid entered by speech via a microphone can be used to identify the user by employing voice pattern recognition. Still further, facial and or retinal pattern recognition can be performed by an imaging device to automatically identify a user entering a bid. The advantages of an implementation employing biometric data are many, and biometric data can also be combined with use of a bid code to increase security. One of the primary advantages of an implementation of the present invention with biometric data is the potential for increased speed and ease of use, in combination with simplification of the method of the present invention.

While an implementation employing biometric data serves to simplify the method of the present invention, it may prove undesirable due to market forces existing at the time of implementation of the present invention. Therefore, a method of operating an auction according to the present invention is described more fully below with reference to use of a registration process employing a computer readable recording medium that does not rely on use of biometric data. It should be readily understood that the method of the present invention as detailed below can be altered from the description thereof to accommodate use of biometric data, thereby eliminating several steps and potentially implementing additional steps.

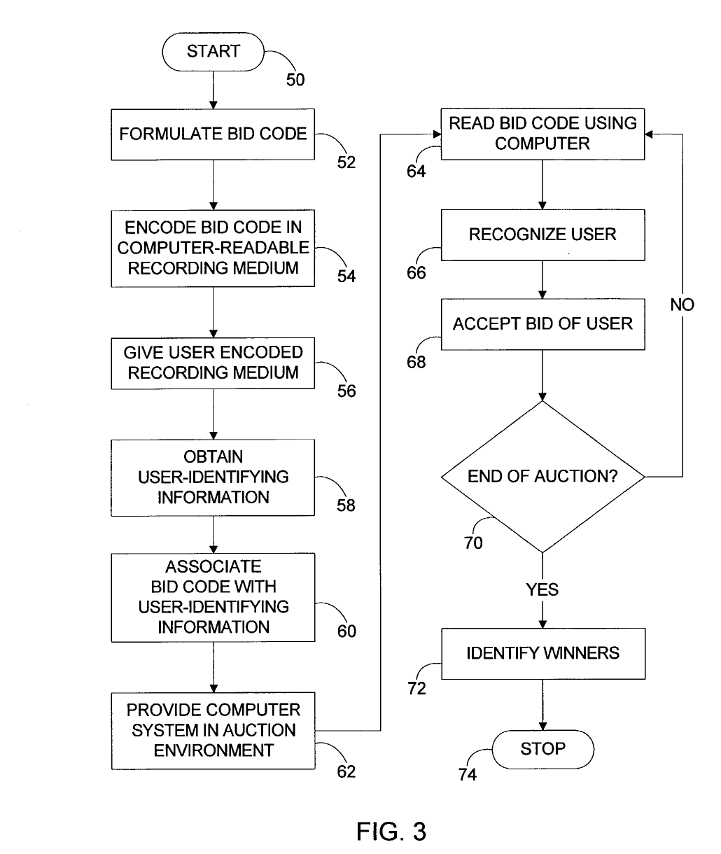

The method of operating an auction is described more fully below with reference to FIG. 3. Therein, the method begins at 50 and proceeds to step 52, wherein a bid code is formulated for use in identifying a user. The bid code is unique with respect to other bid codes that are generated for the same auction, and the form of the bid code varies depending on the implementation of for storing the bid code. In one exemplary embodiment, the bid code takes the form of a standard UPC-A bar code.

The method proceeds from step 52 to step 54, wherein the bid code is encoded in a computer-readable recording medium. The type of recording medium and method for encoding may vary in a complementary manner. In a presently preferred embodiment, the encoding takes the form of a standard UPC-A bar code recorded on a substrate that corresponds to a business card-sized card. The card also preferably has the bid code numerically represented thereon together with a bulls eye and instructions for scanning the card.

The method proceeds from step 54 to step 56, wherein the user is given physical possession of the computer-readable recording medium. Thenceforth, the method comprises obtaining user-identifying information from the user (such as name and address) at step 58, and associating the bid code with the user identifying information in a data store of a computer system at step 60. In a preferred embodiment, steps 56-60 correspond to giving the user the card bearing the bar code, requiring the user to enter personal information in an electronic form on a computer system, and requiring the user to scan the card to obtain the bid code, such that the entered personal information and the scanned bid code are stored in memory on an associated server system.

Following the registration process comprising the previous steps of the method, the method proceeds to step 62, wherein a computer system is provided in an auction environment that is operable to read the computer readable recording medium at step 64, thereby recognizing the user at step 66, and to accept a bid amount from a user based on the recognition at step 68. In a presently preferred embodiment, the computer system is operable to receive a bid amount entered by a user using an electronic form and a form filling application, scan the bar code on the card to obtain the bid code using a bar code scanner, retrieve personal information from memory on the associated server system, confirm the bid amount based on the retrieved personal information, thereby accepting the bid, and, as part of the acceptance process, record the bid in memory on the server system in association with the retrieved personal information and an item up for auction selected by a user. Unless the auction has ended as at 70, the method returns to step 64 and continues recursively to allow the user to place additional and/or new bids in the manner described above. When the auction ends as at 70, winning bidders are identified at step 72 and the method ends at 74.

As mentioned previously, the present invention is described above with reference to use of a registration process that correlates a registered user's identifying information with a bid code, and a bidding process that assumes user possession of a substrate (card) having the bid code recorded thereupon in the form of a bar code. It should be readily understood, however, that other types of recording media can be used including a magnetic strip on a card, a flash memory in a key chain or pen, and a laser-readable disc. It should also be understood that the registration and bidding process can employ biometrics, thereby registering and/or identifying a user based on one or more behavioral and/or physical characteristics including fingerprint, retinal pattern, facial characteristics, voiceprint, DNA, and similar measurable biometrics. Thus, in some situations, the user can comprise the computer readable recording medium within the meaning of the present invention. It should also be understood that, although the present invention is described above as employing a registration process, it is also possible to accomplish the present invention using existing databases of user identifying data, or where the information contained in a computer readable recording medium is inherently sufficient to identify a user for bidding purposes. For example, users may be able to swipe a credit card to initiate a session and have any winning bids charged to the card. Also, users may be able to swipe a driver's license having a magnetic strip if the associated government's driving records are available. Further, a commercial public database may become available that provides telephone and address information for users coincident with biometrics information. Such variations are not to be regarded as a departure from the spirit and scope of the invention.

What is claimed is:

1. A method of administering a silent auction using a computer-implemented auction system, comprising:
receiving a bid on an item up for auction from the user via a computer system;
capturing encoded information embodied in a computer-readable recording medium via the computer system;
recognizing the user based on the encoded information; and
processing the bid in response to said recognizing.

2. The method of claim 1 further comprising:
formulating a bid code;
encoding the bid code in the computer-readable recording medium;
obtaining user-identifying information that identifies the user;
associating the bid code with the user-identifying information in a data store, thereby registering the user; and
providing the user with the computer-readable recording medium.

3. The method of claim 2 further comprising providing a bidding computer system in an auction environment, the computer system operable to:
(a) read the computer-readable recording medium, thereby obtaining the bid code;
(b) access the data store and, using the bid code, obtain the user-identifying information;
(c) identify the user based on the user-identifying information;
(d) receive input from the identified user; and
(e) execute bidding activity for the identified user based on the received input.

4. The method of claim 3 further comprising providing a registration computer system in a registration environment that is physically co-located with the auction environment, wherein the registration computer system is operable to perform said obtaining and said associating.

5. The method of claim 3, wherein said auction environment corresponds to a silent auction environment requiring physical co-location of users as a condition to presenting users with opportunities to place bids on items up for auction.

6. The method of claim 2, wherein the bid code is encoded as a bar code upon a substrate.

7. The method of claim 2, wherein the bid code is encoded in a magnetic strip disposed upon a substrate.

8. The method of claim 1 further comprising registering a user by correlating user-identifying information with encoded information embodied in a computer-readable recording medium.

9. The method of claim 1 further comprising providing the user with the computer-readable recording medium.

10. The method of claim 1, wherein said capturing encoded information embodied in a computer-readable recording medium corresponds to reading information contained in a magnetic strip affixed to a driver's license of the user.

11. A method of administering a silent auction using a computer-implemented auction system, comprising:
receiving a bid on an item up for auction from a user via a computer system;
capturing biometric data associated with the user;
recognizing the user based on the biometric data; and
accepting the received bid in response to said recognizing.

12. The method of claim 1 1 further comprising:
obtaining user-identifying information that identifies the user; and
associating the biometric data with the user-identifying information in a first data store, thereby registering the user.

13. The method of claim 12, wherein the step of obtaining comprises accessing a second datastore of user-identifying information that identifies the user.

14. The method of claim 12, wherein the step of obtaining comprises receiving input from the user via the computer system, wherein the input identifies the user, thereby obtaining the user-identifying information.

15. The method of claim 11, wherein the step of recognizing comprises:
accessing a datastore of user-identifying information searchable via use of the biometric data.

16. The method of claim 11 further comprising providing a bidding computer system in a silent auction environment, the bidding computer system operable to:
(a) receive a bid from the user;
(b) read a characteristic of the user, thereby capturing the biometric data;
(c) recognize the user based on the biometric data; and
(d) accept the bid based on recognition of the user.

17. The method of claim 16, wherein the silent auction environment requires physical co-location of users as a condition to presenting users with opportunities to place bids on items up for auction.

18. The method of claim 12 further comprising providing a registration computer system in a registration environment, wherein the registration computer system is operable to perform said obtaining and said associating, and wherein said registration environment is co-located with a silent auction environment requiring physical co-location of users as a condition to presenting users with opportunities to place bids on items up for auction.

19. The method of claim 11, wherein said capturing biometric data of the user corresponds to measuring a physical characteristic of the user.

20. The method of claim 19, wherein said measuring a physical characteristic of the user relates to at least one of:
(a) fingerprints;
(b) facial features;
(c) hand prints;
(d) iris patterns;
(e) retinal patterns;
(f) vocal ranges; and
(g) vocal timbres;
(h) height;
(i) weight;
(j) hair color;
(k) eye color; and
(l) skin color.

21. The method of claim 11, wherein said capturing biometric data of the user corresponds to measuring a behavioral characteristic of the user.

22. The method of claim 21, wherein said measuring a behavioral characteristic of the user relates to at least one of:
(a) voice patterns;
(b) handwriting characteristics;
(c) signatures.

23. An automated silent auction environment, comprising:
a registration site, wherein a user registers by providing user-identifying information via a computer system and associating it with a bid code in a data store of the computer system;
a silent auction site, wherein a user places a bid on an item up for auction by entering a bid amount via the computer system, and wherein said silent auction site requires physical co-location of users as a condition to presenting users with opportunities to place bids; and
a computer-readable recording medium in physical possession of the user and having the bid code stored therein, whereby the user confirms an entered bid amount by causing the computer system to read the bid code stored in the computer-readable recording medium, and thereby retrieve the provided user-identifying information from the data store,
wherein the computer system is operable to record the entered bid amount in association with the provided user-identifying information as relevant to an item up for auction selected by the user.

24. The environment of claim 23, wherein the computer system has:
an identification interface operable to read information contained in a computer-readable recording medium;
a recognition module operable to recognize a user based on the read information; and
a user interface operable to accept a bid from the recognized user.

25. The environment of claim 24, wherein said recognition module has a data store of user-identifying information that is accessible via the read information.

26. The environment of claim 25, wherein the data store of user identifying information corresponds to a registration data store containing user identifying-information stored in association with a bid code.

27. The environment of claim 26, wherein the computer-readable recording medium corresponds to a substrate having a bid code encoded thereupon in the form of a bar code, and the user is given possession of the substrate.

28. The environment of claim 26, wherein the computer-readable recording medium corresponds to a substrate having a magnetic strip disposed thereupon with the bid code encoded therein, wherein the user is given physical possession of the substrate.

29. The environment of claim 24, comprising:
a data store of items up for auction; and
a bid recording module operable to record the bid in association with a selected item up for auction.

30. The system of claim 23, comprising:
a data store of items up for auction; and
a bid status module operable to ascertain a bid status relating to a highest bid placed with respect to a selected item up for auction.
